(19) United States
(12) Patent Application Publication
(10) Pub. No.: US 2004/0199759 A1
(43) Pub. Date: Oct. 7, 2004

(54) Method for producing diagrammatic network plans

(76) Inventors: Ulrich Lauther, Munchen (DE); Andreas Stubinger, Passau (DE); Frank Oliver Malisch, Neubiberg (DE); Peter Dostert, Munchen (DE)

Correspondence Address: MORRISON & FOERSTER LLP, 1650 TYSONS BOULEVARD, SUITE 300, MCLEAN, VA, 22102, US

(21) Appl. No.: 10/490,654

(22) PCT Filed: Sep. 16, 2002
(86) PCT No.: PCT/DE02/03455

(30) Foreign Application Priority Data
Sep. 25, 2001 (DE) 10147027.4

(51) Int. Cl. G06F 1/24

(52) U.S. Cl. 713/100

(57) ABSTRACT

The invention concerns a method and a computer programme for producing diagrammatic network plans. On the basis of an existing plan wherein connections are subdivided in line sections, and where line sections can be represented by edges, and network elements delimiting the line segments can be represented by nodes, and where mutually parallel line segments can be associated with profiles, data concerning a spatial arrangement of network elements to be modified are stored in a diagrammatic plan database. By moving away predetermined nodes, edges are assembled and profiles are smoothed. An arrangement of the edges associated with the profiles in the respective profiles is determined by means of an algorithm for competitive mode graphics, which is used on pairs of connections of lines having at least a parallel line segment, while taking into account a plurality of intersection points between the connections of the respective lines.

### CLAIM FOR PRIORITY

This application claims priority to International Application No. PCT/DE02/03455, which was published in the German language on Apr. 3, 2003, which claims the benefit of priority to German Application No. 10147027.4 which was filed in the German language on Sep. 25, 2001.

### TECHNICAL FIELD OF THE INVENTION

The present invention relates to a system and method for producing diagrammatic network plans.

### BACKGROUND OF THE INVENTION

Documenting line networks in energy and water supply systems and also in communication systems, in particular, usually involves the use of master plans containing accurate positions and diagrammatic network plans in a variety of forms of presentation. A master plan contains information about coordinates of all documented network elements, for example line connections, distribution frames, alignments and shafts along alignments. Normally a master plan is held in a Geographical Information System (GIS). A diagrammatic network plan, known as a schematic for short, contains information about documented network elements in a compressed, easy-to-follow and generally not true-to-scale representation.

In Geographical Information Systems both master plans and schematics of a network can be stored and administered separately. However, the effort involved in looking after each type of plan separately is comparatively great for users of a Geographical Information System. In addition looking after the two types of plan separately frequently leads to inconsistencies.

### SUMMARY OF THE INVENTION

The present invention discloses a method and a computer program product for creating diagrammatic network plans which allow a diagrammatic network plan to be quickly derived from a master plan.

One aspect of the present invention is determining an arrangement of edges to be assigned to alignments for the alignment concerned by means of an algorithm for competitive mode graphics considerably speeds up a method for creating diagrammatic network plans. In this case, an algorithm for competitive mode graphics is applied to pairs of line connections with at least one plane-parallel line section, taking into consideration a number of intersection points between the relevant line connections.

The speeding up of a method for creating diagrammatic network plans achieved by the invention makes it possible to automatically generate a diagrammatic plan from a master plan if required and to dispense with a separate, expensive and error-prone maintenance of both types of plan. For example a geographically accurate master plan is declared to be a master plan and exclusively this type of plan is maintained. A diagrammatic plan as an alternative representation is generated automatically for example after a change in the master plan.

### BRIEF DESCRIPTION OF THE DRAWINGS

The present invention will be explained below in greater detail by exemplary embodiments with reference to the drawings. The drawings show:

FIG. 1 shows a section from a master plan of a line network.

FIG. 2 shows a section of a diagrammatic plan assigned to the section shown in FIG. 1.

FIG. 3 shows a flowchart for a method for creating a diagrammatic network plan.

### DETAILED DESCRIPTION OF THE INVENTION

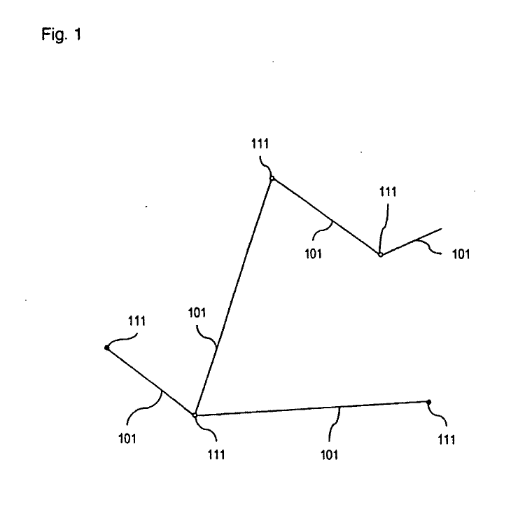

In the section from a master plan of a line network in accordance with FIG. 1, alignments 101 and ends of alignments 111 are shown in their correct geographical position, in which the line network is modeled as a graph with nodes and edges. Parallel line sections run along the alignments 101. In communication networks in particular, a geographically correct representation of line sections in a master plan can be difficult to follow because of the plurality of plane-parallel line sections assigned to each other in different levels. For this reason, a geographically correct representation of alignments instead of line sections is preferred in this diagram. A geographically correct representation of line sections is however basically also possible in a master plan. The following considerations apply in equal measure to this case.

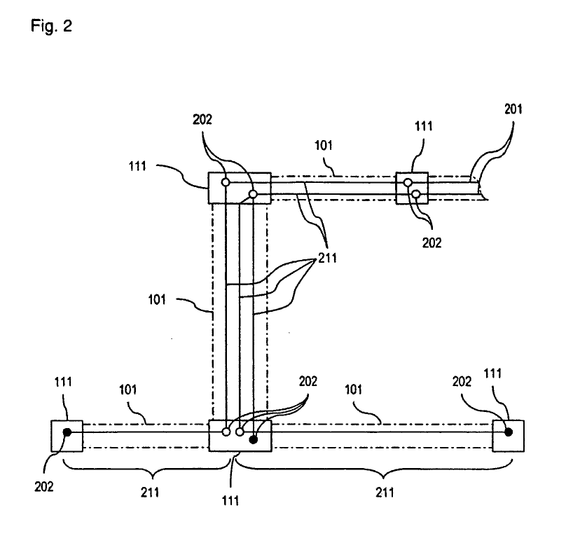

The section of the master plan shown in FIG. 1 is converted in accordance with a method described in greater detail into a diagrammatic plan, a section of which is shown in FIG. 2. The diagrammatic plan shows line sections 211 assigned to an alignment 101 which are delimited by network points 202, which in their turn can be assigned to ends of alignments 111. Line sections 211 which are connected by network points 202 of lesser importance, for example junction boxes as regards running of network administration, or network nodes which do not implement line branching are combined to form line connections 201.

When a diagrammatic plan is created from a master plan intersections in the master plan should have been retained. In addition, no new intersections should have been added. Network elements which in the master plan have a North/South or West/East relationship to each other, should also be arranged accordingly in the diagrammatic plan. Further the alignment of edges in the diagrammatic plan should be along parallel axes where possible. Furthermore hierarchical dependencies between line sections and alignments, between ends of alignments and alignments, between line sections and network points as well as between network points and ends of alignments should also be taken into account in the diagrammatic plan. Because of the hierarchical dependencies ends of alignments and alignments comprise a number of network elements and feature an extension.

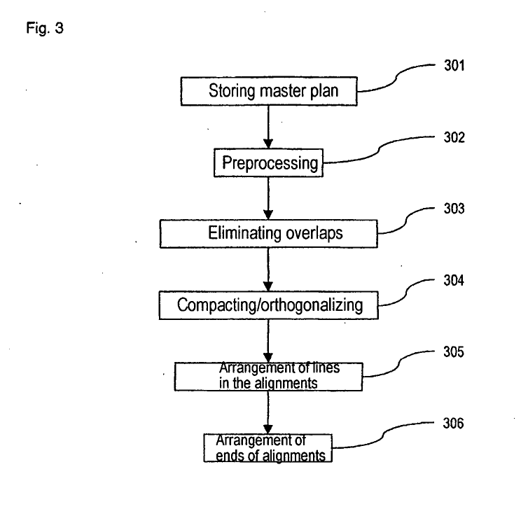

The diagrammatic plan is created as shown in FIG. 3:

Storing the master plan, 301,

Preprocessing, 302,

Eliminating overlaps, 303,

Compacting/orthogonalizing, 304,

Arrangement of lines in the alignments, 305 and

Arrangement of ends of alignments, 306.

In the above, some of which are iterated, the procedure is as follows.

Storing the Master Plan:

Nodes and edges of the master plan are stored with their coordinates and hierarchical dependencies, including associated text labels and control parameters in a diagrammatic plan database, which is dynamically generated when a diagrammatic plan is created. The diagrammatic plan in its turn is generated automatically after a change to the master plan for example.

Preprocessing:

In the diagrammatic plan database nodes with degree 2 are initially removed, in accordance with the Douglas-Peuker algorithm described in D. H. Douglas, T. K. Peucker: “Algorithms for the Reduction of the Number of Points Required Represent a Digitized Line or its Caricature”, The Canadian Cartographer, Vol. 10, No. 2, P. 112-122, 1973. This produces an assembling of edges and a smoothing of alignments. Intersections are eliminated by inserting auxiliary nodes into the relevant edges. In this way a planar graph is created.

From the assignment of network points and line sections to ends of alignments and alignments, minimum widths for alignments are determined from which minimum dimensions for ends of alignments are determined. The minimum dimensions here are produced from the number of line sections within an alignment and from a specified gap between edges.

Elimination of Overlaps:

After the minimum dimensions for alignment nodes have been determined multiple mutually overlapping alignment nodes are produced. These are handled initially by means of different scaling heuristics.

The algorithm used for the elimination of overlaps is based on a spring embedder which is described in T. M. J. Fruchterman, E. M. Reingold: “Graph Drawing by Force-Directed Placement” Software—Practice and Experience, Vol. 21, P. 1129-1164, 1991 and A. Frick, A. Ludwig, H. Mehldau: “A Fast Adaptive Layout Algorithm for Undirected Graphs”, Proc. Graph Drawing 1994, LNCS 894, P. 388-403, Springer Verlag, 1995. Such a spring embedder is based on the idea of a spring model. Repelling forces operate between two nodes in each case whereas attracting forces operate along an edge on the adjacent node in each case. The mode of operation of the algorithm based on a spring embedder then comprises iteratively establishing equilibrium between the two types of force mentioned. This is achieved by a resulting force acting on it being determined for each node and the node then being correspondingly displaced once per iteration (see T. M. J. Fruchterman, E. M. Reingold: “Graph Drawing by Force-Directed Placement” Software—Practice and Experience, Vol. 21, P. 1129-1164, 1991).

The expansions made to the spring embedder known from the literature quoted above are described below regarding

orthogonality,

position similarity, and

expansion of nodes and edges.

All edges in the diagrammatic plan should be aligned orthogonally where possible. This is achieved by an additional force in the spring model of the spring embedder. Depending on whether the relevant edge runs more vertically or more horizontally, corresponding forces will be exercised on the node which limit the relevant edge in order to push the edge further in the relevant direction.

The position relationship of the nodes to each other should be retained as much as possible. To do this, a check is made before each node displacement as to whether the relevant node would cross another edge, or whether an edge delimited by the relevant node would cross another node. If one of these two conditions is fulfilled, the relevant node is only displaced to a limited extent. degree 2 nodes, which can be displaced by any amount, form an exception here.

With displacements of nodes and edges, it must also be ensured that the minimum gaps between nodes and edges are maintained. To this end, for reasons of efficiency, the set of all adjacent nodes and edges is determined and stored in a list for each node at the beginning of each iteration. The set of adjacent nodes and edges is determined for example with the aid of “kd Trees”, which are described in J. L. Bentley: “Multidimensional Binary Search Trees used for Associative Searching”, Comm. of the ACM, 18.9.1975, P. 509-517 and U. Lauther: “A Data Structure for Gridless Routing”, Proc. 17th Design Automation Conf., 1980, P. 603-609. These types of lists can also be used for efficient calculation of repelling forces in the spring model of a spring embedder.

Compacting/Orthogonalizing:

The above method creates diagrammatic plans which merely feature edges with approximate, not exactly parallel axes and a multiplicity of unnecessary empty spaces. This problem is resolved as follows.

For design of VLSI (Very Large Scale Integration) system,s compacting methods are known in which space conditions are formulated as inequalities between coordinates of objects are known from M. Y. Hsu: “symbol Layout and Compaction of Integrated Circuits”, Technical Report UCB/ERL M79/80, Electronics Research Laboratory, University of California, Berkeley, Calif., 1979. A solution of a resulting inequality system produces a compacted representation which complies with all spacing conditions. A set of inequalities needed can be determined efficiently by a “Plane-Sweep” procedure which is described in T. Lengauer “Efficient Algorithms for the Constraint Generation for Integrated Circuit Layout Compaction”, Proc. of the WG'83, Intern. Workshop on Graphitheoretic Concepts in Computer Science, Auth. M. Nagl, J. Perl, P. 219-230.

Compared to the method known from the literature quoted above additional equations are introduced to ensure orientation along a parallel axis of most edges. For alignments which lie almost horizontally as a result of additional forces in the spring embedder an equality is introduced which specifies the same y-coordinates for the two associated nodes. This applies analogously to almost vertical edges. A system of equalities and inequalities arranged in this way can be handled as a directed graph and is efficiently resolved by a “shortest path” algorithm, for example.

Arrangement of Lines in the Alignments:

For as clear as possible an arrangement of line connections or line sections within alignments or alignment sections, it should be noted that a line connection can pass over a number of alignment sections. Thus the arrangement of lines in the alignments does not just relate to the arrangement of line sections within a local alignment section. Instead, the arrangement of lines in the alignments additionally relates to the following aspects:

Retaining the relative positions between line connections over a number of alignment sections, and

Minimizing the line section intersections to be expected within ends of alignments in the sense of a simplified, subsequent, end of alignment layout.

To determine a suitable arrangement of line sections within alignment sections the method investigates how the relative positions between line connections affect the number of intersection points within the alignment sections or ends of alignments. This is done by determining for each pair of line connections with a first and a second line connection, the number of intersection points between the first and the second line connection for the case where the first line connection is arranged to the left of or above the second line connection. Subsequently the number of intersection points is determined for the reverse case.

With two line connections to be arranged in alignments, a simple selection rule is produced for arranging the first and the second line connections. Thereafter, the arrangement with the lower number of intersection points is selected from the two possible arrangements. For more than two line connections arranged in alignments configurations can however be produced in which for example in accordance with the selection rule formulated for an arrangement of two line connections the first line connection is to be arranged to the left of the second line connection, the second line connection is to be arranged to the left of a third line connection and the third line connection is to be arranged to the left of a first line connection.

To avoid these types of conflict an arrangement of edges within the relevant alignment assigned to alignments is determined by an algorithm for competitive mode graphics. An algorithm for competitive mode graphics is applied here to pairs of line connections with at least one plane-parallel line section, taking into account the number of intersection points between the relevant line connections. As a result, a table is determined by competitive mode graphics in which the relevant line connections are entered in an order corresponding to their relative arrangement on the diagrammatic plan.

Extensive theory exists for competitive mode graphics which forms a subarea of graph theory, especially game theory, and to which reference is made at this point. The outstanding feature of the method described for arrangement of lines in the alignments is its particular speed and efficiency and it makes a major contribution to the accelerated creation of diagrammatic plans. The accelerated creation of diagrammatic plans is in its turn a requirement for generating a diagrammatic plan from a master plan where necessary and for dispensing with the separate maintenance of master plan and diagrammatic plan which leads to inconsistencies.

Arrangement of Ends of Alignments:

Determining coordinates for network points within ends of alignments and determining a graph of line sections within alignments is described below. The previous arrangement of lines in the alignments already defines positions for line sections determined in the relevant end of alignment and line sections exiting from this.

Determining an arrangement of ends of alignments should produce as few intersection points between line sections as possible. Line sections should, where possible, meet each other at network points. For unavoidable intersection points between line sections the relevant line sections at these intersection points should meet each other orthogonally.

To determine the arrangement of ends of alignments for example a pattern router and a Lee router are used in combination. Both methods are originally provided for automatic artwork design of circuit boards.

Since through the arrangement of lines in the alignments positions for the line sections entering into the relevant end of alignment and exiting from this are already determined, determining the arrangement of the ends of the alignments at the individual alignments is handled locally in each case. An arrangement of ends of alignments usually features a number of subgraphs, which in their turn are often subdivided into simple associated subgraph components and frequently feature a network point as well as more than two line ports. The handling of the subgraph components is described below.

1. From the relevant subgraph components two network points are selected which lie at the edge of an end of alignment and can be connected by means of a simple pattern, for example u-shape, z-shape, straight line or orthogonal.

2. A third line connection on the edge of the alignment end is selected and connected. This defines the coordinates of the associated network point.

3. Using “Dijkstra's shortest path algorithm” the other line ports are connected. “Dijkstra's shortest path algorithm” uses “Manhattan metric”. This means that line sections intersect exclusively orthogonally at intersection points.

4. The other network points of the relevant subgraph components are linked within the associated alignment end.

Since heuristics which do not guarantee any optimum are applied in the above step to handle subgraph components, there is the option of permutating the above method.

The method described here for creating diagrammatic plans may be implemented by a computer program product which can be loaded into the main memory of a data processing system and features at least one code section, for the execution of which the steps previously described are performed when the computer program product runs in the data processing system.

The application of this invention is not restricted to the exemplary embodiment described here.

What is claimed is:

1. A method for producing diagrammatic network plans, comprising:
subdividing line connections into line sections the line sections being represented by edges and network elements delimiting the line sections by nodes and the line sections running in parallel being assigned to alignments;
storing information about a spatial arrangement of the network elements for changing into a diagrammatic plan database;
combining edges by moving away specifiable nodes, thereby smoothing alignments;
determining an arrangement of edges assigned to alignments in the relevant alignment using an algorithm for competitive mode graphics which is applied to a pair of the line connections with at least one plane-parallel line section, taking account of a number of intersection points between the relevant line connections.

2. The method in accordance with claim 1, wherein the diagrammatic plan database is created dynamically.

3. The method according to one of claims 1, wherein the diagrammatic network plan is created automatically.

4. The method in accordance with claim 1, wherein minimum widths for the alignments are determined from assignments of the line sections to the alignments and specifiable minimum gaps between edges.

5. The emthod in accordance with claim 4, wherein minimum dimensions for ends of the alignments are determined from assignments of the network elements delimiting the line sections to ends of the alignments, from assignments of ends of the alignments to the alignments and from the minimum width determined for ends of the alignments.

6. A computer program product which can be loaded into a main memory of a data processing system and has at least one code section, the computer program product executable by a computer and performing:
reading in from a master plan, in which line connections are subdivided into line sections, the line sections being represented by edges and network elements delimiting the line sections by nodes and the line section running in parallel being assigned to alignments, information about a spatial arrangement of the network elements for changing into a diagrammatic plan database;
combining edges by moving away specifiable nodes, therebry smoothing the alignments;
determining an arrangement of the edges in the relevant alignment assigned to the alignments using an algorithm for competitive mode graphics, which is applied to pairs of the line connections with at least one plane-parallel line section taking into consideration a number of intersection points between the relevant line connections.
